(19) United States
(12) Patent Application Publication
(10) Pub. No.: US 2017/0039623 A1
(43) Pub. Date: Feb. 9, 2017

(54) ON-DEMAND SUPPLY AND STORAGE SYSTEM AND METHOD

(71) Applicant: Mark Boraski, Austin, TX (US)

(72) Inventor: Mark Boraski, Austin, TX (US)

(21) Appl. No.: 14/821,448

(22) Filed: Aug. 7, 2015

(51) Int. Cl. G06Q 30/06; G06Q 10/08; H04L 29/08

(52) U.S. Cl. CPC G06Q 30/0633; H04L 67/32; H04L 67/16; H04L 67/18; G06Q 10/087

(57) ABSTRACT

A method for on-demand product and service delivery includes receiving by a server computer communicatively connected to a network, a request from a customer device communicatively connected to the network, matching by the server computer the request from the customer device to a partner device at a location corresponding to the customer device, the partner device having registered with the server computer at the location, sending by the server computer the partner device an identifier of the customer device at the location and a product or service identity for delivery to the customer device for the request, receiving by the server computer a confirmation message from the partner device that the request is fulfilled by delivery of the product or service by the partner device to the customer device, updating by the server computer a record of the product or service in a database communicatively connected to the server computer, offering by the server computer for purchase by the partner device, the product for delivery to the customer device on request in the step of receiving the request, selling by the server computer the product to the partner device, storing by the server computer in the database a record of the step of selling, relative to the partner device, and updating by the server computer the record of the product or service in the database.

### TECHNICAL FIELD

The invention generally relates to computer communications and supply chain logistics, and more particularly relates to systems and methods for product management and storage and on-demand service networking of computing devices.

### BACKGROUND

Variables affecting supply chain logistics can include storage, temporal (e.g., geographic), and transit features, as well as others. Products and services for consumption must be managed/stored to assure availability. Moreover, products and services must be positioned, geographically and relatively, for ready access and provision. Lading and carriage typically require facilities, equipment, movement, and time for their employment or operations.

### SUMMARY

An embodiment of the invention is a system for on-demand product and service delivery by a partner device communicatively connected to a telecommunications network, responsive to a request by a customer device communicatively connected to the telecommunications network. The system includes a server computer communicatively connected to the telecommunications network, including an on-demand manager and a product manager communicatively connected to a processor and memory, the on-demand manager connecting the customer device to the partner device for fulfillment of the request by delivery of product or service by the partner device, and the product manager providing product purchasable by the partner device for fulfillment of the request by delivery of product to the customer device, and a database communicatively connected to the telecommunications network, the database includes partner and client records for connecting the customer device to the partner device and product management records for product stored by the partner device for delivery to the customer device.

Another embodiment of the invention is a method for on-demand product and service delivery. The method includes receiving by a server computer communicatively connected to a network, a request from a customer device communicatively connected to the network, matching by the server computer the request from the customer device to a partner device at a location corresponding to the customer device, the partner device having registered with the server computer at the location, sending by the server computer the partner device an identifier of the customer device at the location and a product or service identity for delivery to the customer device for the request, receiving by the server computer a confirmation message from the partner device that the request is fulfilled by delivery of the product or service by the partner device to the customer device, and updating by the server computer a record of the product or service in a database communicatively connected to the server computer.

In further aspects, the method includes offering by the server computer for purchase by the partner device, the product for delivery to the customer device on request in the step of receiving the request, selling by the server computer the product to the partner device, storing by the server computer in the database a record of the step of selling, relative to the partner device, and updating by the server computer the record of the product or service in the database.

Another embodiment of the invention is a system for on-demand product and service delivery by a partner device communicatively connected to a telecommunications network, responsive to a request by a customer device communicatively connected to the telecommunications network. The system includes a server computer communicatively connected to the telecommunications network, including an on-demand manager and a product manager communicatively connected to a processor and memory, the on-demand manager connecting the customer device to the partner device for fulfillment of the request by delivery of product or service by the partner device. The on-demand manager includes instructions for receiving an availability message from the partner device on the network, determining a location of the partner device, determining in a database an inventory of the product or service then-maintained by the partner device, receiving a request from the customer device on the network, determining a location of the customer device, matching the request via the location of the customer device to the partner device via the location of the partner device and the inventory then-maintained by the partner device, sending the partner device an identifier of the customer device and a product or service identity for delivery to the customer device for the request, receiving a confirmation message from the partner device that the request is fulfilled by delivery of the product or service by the partner device to the customer device, and updating a record of the product or service in the database.

In further aspects, the product manager of the system includes instructions for sending an offer for sale of product to the partner device, selling the product to the partner device, storing in the database a record of the sale of the product to the partner device, and updating an inventory in the database of the product for the partner device.

Yet another embodiment of the invention is a method for on-demand product storage and delivery via a data communications network. The method includes receiving an availability message from a partner device communicatively connected to the network, determining a location of the partner device, determining in a database an inventory of the product then-maintained by the partner device, receiving a request for the product from a customer device on the network, determining a location of the customer device, matching the request via the location of the customer device to the partner device via the location of the partner device and the inventory then-maintained by the partner device, sending the partner device an identifier of the customer device and an identity of the product for delivery to the customer device for the request, receiving a confirmation message from the partner device that the request is fulfilled by delivery of the product by the partner device to the customer device, and recording an update to a record of the product for the partner device.

Another embodiment of the invention is a method for on-demand product storage and delivery via a data communications network. The method includes sending an offer for sale of a product to a partner device communicatively connected to the network, selling the product to the partner device, storing in a database a record of the sale of the product to the partner device, and updating an inventory in the database of the product for the partner device.

Yet another embodiment of the invention is a method for on-demand product or service receipt by a customer device via a communication network. The method includes sending by the customer device to a server computer a request for the product or service, the request includes a requirement of either of on-demand delivery and same day delivery, receiving from the server computer an acknowledgement that the product or service will be delivered as per the requirement, and purchasing by the customer device via communication with the server computer over the network the product or service of the request.

### BRIEF DESCRIPTION OF THE DRAWINGS

The present invention is illustrated by way of example and not limitation in the accompanying figures, in which like references indicate similar elements, and in which:

FIG. 1 illustrates a system for on-demand supply and storage of products or services, including partner devices and customer devices, according to certain embodiments;

FIG. 2 illustrates a server system for receiving requests for products or services from customer devices, for delivering products or services by partner devices pursuant to those requests, and for coordinating and managing supply and storage of the products and services, according to certain embodiments;

FIG. 3 illustrates a method for on-demand supply and storage of products or services by a server computer and database, according to certain embodiments;

FIG. 4 illustrates a method for ordering, managing, and storing products and services by a partner device, and fulfilling by the partner device requests for product or service from customer devices, via communications with a server computer, according to certain embodiments;

FIG. 5 illustrates a method for requesting and confirming delivery of products or services by a customer device, via communications with a server computer, according to certain embodiments;

FIG. 6 illustrates an example of operation of a system and method for on-demand supply and storage of products or services, according to certain embodiments;

FIG. 7 illustrates an example of operation of a partner communications device, according to certain embodiments; and

FIG. 8 illustrates an example of operation of a customer communications device, according to certain embodiments.

### DETAILED DESCRIPTION

The following description refers to certain specific embodiments; however, the specific embodiments are merely illustrative and variations and changes may be made in the embodiments without diverting from the broad scope encompassed by the disclosure. For purposes of the following detailed description and examples:

As employed in the embodiments, a “customer” refers to an individual operating a communications device (and, unless the context otherwise requires, the device itself) to request or order a product or service for on-demand delivery; and a “partner” refers to an individual operating a communications device (and, unless the context otherwise requires, the device itself) to indicate availability and readiness to deliver, and to deliver, products or services to customers, and to manage stocks of products or services on hand for ready delivery.

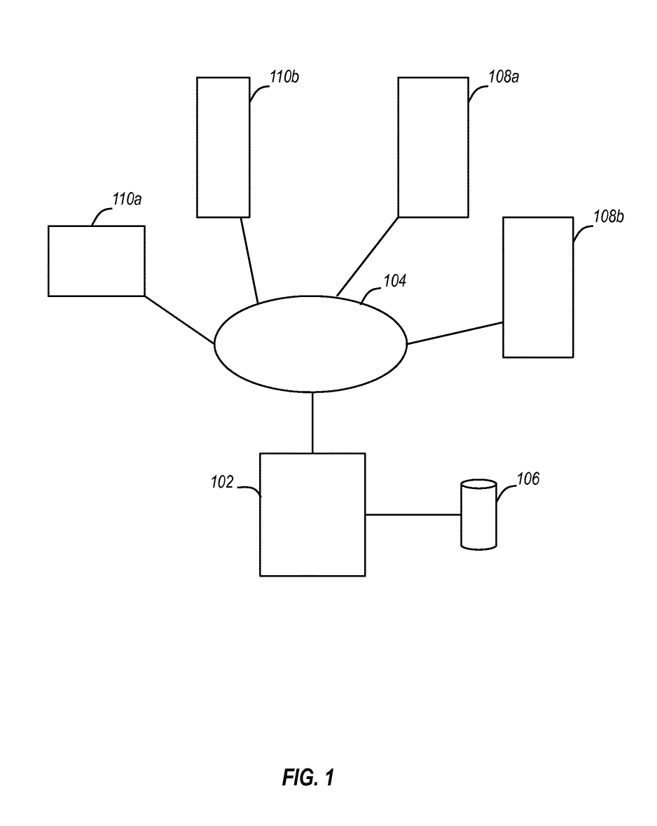

Referring to FIG. 1, a system 100 includes a manager engine 102. The manager engine 102 is communicatively connected to a communications network 104. The network 104 may be any one or more wireless or wired data communications link or network, or combination of those links or networks, for example, cellular, Wifi, Internet, intranet, virtual private network (VPN), local area network (LAN), wide area network (WAN), optical network, and others. The manager engine 102 includes communications elements for sending and receiving communications signals of the network 104. Although the manager engine 102 is illustrated as a single entity in the Figures, it should be understood that the manager engine 102 may be unitary or implemented in pluralities of elements.

The manager engine 102 communicatively connects to, or otherwise includes, a data storage 106. The data storage 106 may be, include or communicatively connect to a computer-readable medium, for example, permanent memory storage device, portable storage unit, flash memory, optical memory, magnetic memory or other data store, and may be one or more such data store.

The network 104 is communicatively connected to one or more of a partner communications device 110a, 110b. The partner communications device 110a, 110b may, for example, be or include a browser device as illustrated by partner communications device 110a, an app-enabled device as illustrated by partner communications device 110b, or other communicative processing device. The partner communications device 110a and/or 110b communicates with the manager engine 102 over the network 104. Although two of the partner communications device 110a, 110b are illustrated in the Figures, it should be understood that any greater or fewer number are possible in the embodiments.

One or more of a customer communications device 108a, 108b is communicatively connected to the network 104. The customer communications device 108a, 108b may, for example, be or include an app-enabled device as illustrated by customer communications device 108a, a browser device as illustrated by customer communications device 108b, or other communicative processing device. Each customer communications device 108a and 108b communicates with the manager engine 102 over the network 104. Although two of the customer communications device 108a, 108b are illustrated in the Figures, it should be understood that any greater or fewer number are possible in the embodiments.

In operation, the customer communications device 108a or 108b (as may be applicable; and hereafter referred to by reference number “108”) and the partner communications device 110a or 110b (as may be applicable; and hereafter referred to by reference number “110”) communicate over the network 104 with the manager engine 102. The customer communications device 108 communicates to the manager engine 102 a request for product or service. The partner communications device 110 communicates to the manager engine 102 an indication of availability for fulfilling requests of the customer communications device 108 for product or service. Initially, the partner communications device 110 must satisfy requirements to become a provider of products or services via the system. The requirements may include, for example, agreement to contractual terms, background check, and setting identifiers and a profile for the partner communications device 110. The partner communications device 110 must also purchase supplies of product(s) if to be provided via the partner communications device 110, and/or identify the service(s) if to be provided via the partner communications device 110. Purchase of product(s) for supplies is managed by the manager engine 102, as further described.

Thereafter, on initial communication of the partner communications device 110 with the manager engine 102, the manager engine 102 determines a location (e.g., geographical, on the network, or otherwise) of the partner communications device 110, for example, the determination is made automatically by the manager engine 102 or else the partner communications device 110 communicates the location. The partner communications device 110 communicates a desired service medium (e.g., pedestrian, bicycle or vehicle delivery, hand delivery, parcel post, or other) for fulfilling requests of the customer communications device 108. The manager engine 102 thereafter intermittently or continuously pings the partner communications device 110 to confirm availability of the partner communications device 110.

The customer communications device 108 communicates to the manager engine

102 the request for product or service. The manager engine 102 receiving the request matches the request, including via location of the customer communications device 108 (as well as possibly other matching criteria, such as inventory maintained by the device 108 as described herein, or otherwise), to the partner communications device 110. The manager engine 102 then communicates the request to the partner communications device 110, and the partner communications device 110 receives the request and identifiers of the customer communication device 108, for example, via location and unique identifier (as well as possibly other criteria, such as product or service of the request, inventory maintained, and others).

The partner communications device 110, on provision of the product or service of the request by the customer communications device 108, communicates to the manager engine 102 a notification that the service was completed or product was delivered, as applicable. The manager engine 102 maintains records of product(s) purchased by the partner communications device 110. Based on the records, the manager engine 102 assesses current stocks of product(s) maintained in association with the partner communications device 110. The manager engine 102, based on analytical assessments of requests received for product(s) and service(s), communicates to the partner communications device 110 recommendations of additional product(s) or service(s). The manager engine 102 also may communicate, at this or any other time, to the partner communications device 110 various recommendations regarding product, storage and handling requirements, and inventory rotation and other management advisories.

The manager engine 102 includes or communicatively connects to a commerce engine (not shown in FIG. 1). The manager engine 102 sells products to the partner communications devices 110, for those devices to fulfill requests of customer communications devices 108. The manager engine 102 also collects the purchase price from customer communications devices 108 for product(s) and service(s) provided by the partner communications devices 110 pursuant to requests of the customer communications devices 108. The manager engine 102 pays a portion of its collections to the partner communications device 110 on fulfilling the request.

In effect, the manager engine 102 manages inventory supplies of product(s) and service(s) of each partner 110 and directs the partner 110 to maintain applicable inventories. The manager engine 102 receives purchase price for product(s) sold to the partner 110. The manager engine 102 also facilitates provision of product(s) and service(s) to the customer 108, via the partner 110. The manager engine 102 receives the purchase price for product(s) and service(s) received by the customer 108 from the partner 110. The manager engine 102 manages monies received, and pays portion to the partner 110.

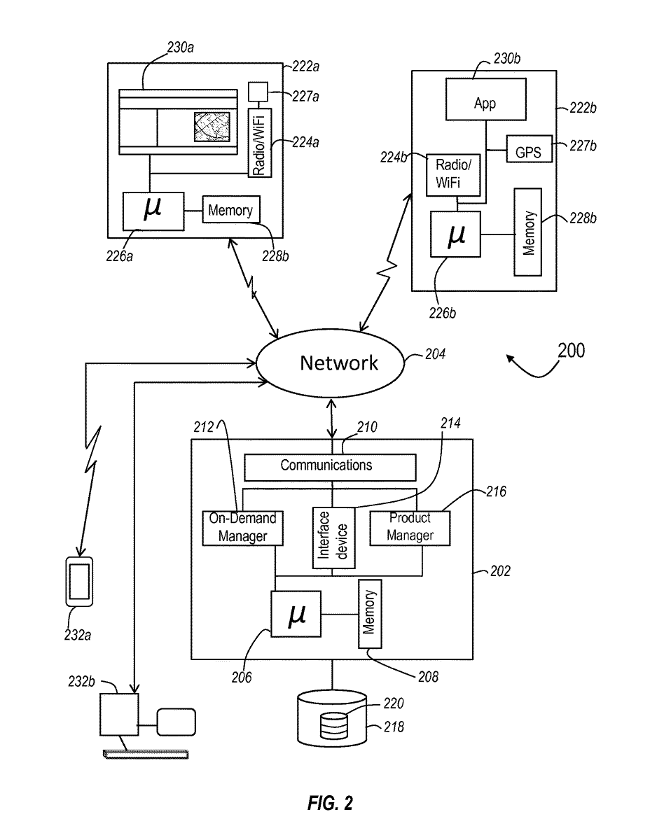

Referring to FIG. 2, a system 200, for example, such as the manager engine 102 of FIG. 1, is, includes or communicatively connects to a computer, as non-exclusive example, a server computer 202. The server computer 202 is communicatively connected to a communications network 204. The server computer 202 may be one or more computing device, including but not limited to one or more servers, providing the functionalities and elements herein described.

In certain non-exclusive embodiments, the server computer 202 includes or communicatively connects to a processor 206 and memory 208 communicatively connected to the processor 206. The processor 206 may be a general purpose processor or embedded processor that includes or is configured to access one or more computer-accessible media containing controlling software or other programmatic controls. The processor 206 may be a specially configured processor, as nonexclusive example, an application specific integrated circuit (ASIC) or other circuit or logic device for performing the operations of the server computer 202 or that includes or is configured to access one or more computer-accessible media containing controlling software or other programmatic controls, or any combination of these. The processor 206 may further be one or more processor, or combination of different types of processor.

The memory 208 in the non-exclusive embodiments is, includes or communicatively accesses any type of computer-readable medium, including but not limited to, random access memory (RAM), read only memory (ROM), erasable programmable memory (EPROM or EEPROM), flash memory, hard drive, such as solid state drive device, portable storage units, such as CD or DVD units, magnetic memory, optical memory, and any other storage device or storage system suitable for storage of instructions and data accessible by the processor 206.

The server computer 202 may also include or communicatively connect to a communication interface device 210, an on-demand manager 212, a manager interface device 214, and a product manager 216. Each of the communication interface device 210, the on-demand manager 212, the manager interface device 214 and the product manager 216 may be implemented in hardware or software stored in tangible media, or combinations of such hardware and software. If implemented in software, the device 210, 214 or manager 212, 216, or portion(s) thereof, as applicable, may be stored within the memory 208 or other computer-readable medium, for operating with and controlling the processor 206 through program instructions and data, for performing the functions, such as methods and techniques, described herein.

A data store 218 may be included in or communicatively connected to the server computer 202. Non-exclusive examples of the data store 218 include redundant array of independent disks (RAID) devices, disk drives or other arrays of disk drives, solid state drive devices, optical storage devices, magnetic storage devices, tape drives, network access storage (NAS) devices, or other storage device or combinations of these. The data store 218 may be one or more storage device configured to store instructions and data used by the server computer 202.

The data store 218 may store information in a database 220 or other format, such as files stored in any of various file formats, for performing the functions, such as methods and techniques, described herein. Non-exclusive examples of the database 220 include one or more of a relational database, object oriented database, or other type of database, or combinations. In certain embodiments, the database 220 may include a customer database configured for storing information about customers that request products or services of the system 200 and a partner database configured for storing information about partners authorized to provide products or services responsive to customer requests. The database 220 may, in certain embodiments, include payment and billing information, as well as other information in accordance with the functions, such as methods and techniques, described herein. The database 220 may be unitary, or may be segregated or more than one database, according to desired implementation.

One or more partner device 222a, 222b may communicatively connect to the server computer 202 via the network 204. Certain non-exclusive examples of the network 204 include a wide area network (WAN), the Internet, or other communications link or network, or combination. Each partner device 222a, 222b includes communications elements 224a, 224b, respectively, for transmitting and receiving communicated signals of the server computer 204 on the network 204. The communications elements 224a, 224b may be wired or wireless, or other channel or link, including but not limited to cellular, WiFi, infrared, cable, or other.

In certain non-exclusive embodiments, as illustrated, partner devices 222a and 222b wirelessly communicatively connect to the network 204 for on-demand provision of products or services in response to requests by customer devices. Each partner device 222a, 222b may include a processor 226a, 226b, respectively, and memory 228a, 228b, respectively. A locator device 227a, 227b, respectively, such as a global positioning system (GPS) device 227b, an IP address 227a, a manually entered location identifier, or other locator system, is included in or communicatively connected to, or input to, the partner device 222a, 222b, for location of the device 222a, 222b by the server computer 202. Non-exclusive examples of the partner device 222a include a browser device, such as a browser application 230a stored in memory and processed by a processor of a laptop computer, tablet device, or other mobile or stationary device and communicative with a web server of the server computer 202 (e.g., such as to pull the application through the browser), and of the partner device 222b include an app device 230b stored in memory and processed by a processor of a smartphone, tablet device, or other mobile device, which app device 230b may be, in whole or part, included in the app device 230b, included in another device communicatively accessible to the app device 230b (e.g., stored in memory of the server computer 202 or otherwise), or other.

One or more customer device 232a, 232b may also communicatively connect to the server computer 202 via the network 204. Each customer device 232a, 232b includes communications elements for transmitting requests and receiving communicated signals of the server computer 202 on the network 204. The customer devices 232a, 232b may communicate with the network 204 wired or wirelessly, including but not limited to cellular, WiFi, infrared, cable, or other.

In certain non-exclusive embodiments, as illustrated, customer device 232a wirelessly communicatively connects to the network 204 for requesting products or services and other communications with the server computer 202, and customer device 232b is wired to communicatively connect to the network 204 for such purpose. Each customer device 232a, 232b may include a respective processor and memory, and respective locator device, such as a GPS device, an IP address, a manually entered location identifier (e.g., street address), or other locator system, for location of the device 232a, 232b, respectively, for provision of products or services requested. Non-exclusive examples of the customer device 232a include a cellular or WiFi enabled browser or app device, such as a smartphone, tablet device, laptop computer, or other mobile device, and of the customer device 232b include a wired browser or app device, such as any of those devices or stationary device.

In operation, the partner device 222a or 222b (as may be applicable; and hereafter referred to by reference numeral “222”), and if more than one, each of them, logs in through a browser 230a or app device 230b of the partner device 222. The browser 230a or app device 230b, as applicable, communicates to the server computer 202 an indicator of availability of the partner device for delivery of product(s) or service(s), either for immediate delivery or other delivery. If the indicator of availability is for immediate delivery, a location of the partner device 222 is determined, such as, for non-exclusive example, by communicated global position identified by GPS 227b of the partner device 222b, by detected or communicated IP address 227a of the partner device 222a, by communicated input manually entered to the partner device 222, or otherwise. If the indicator of availability is other than for immediate delivery, a locator of the partner device 222 is determined and the partner device 222 may provide, via input to the partner device 222 or otherwise that is communicated to the server computer 202, a destined location for delivery at later time.

Along with determination of the location, the partner device 222 communicates to the server computer 202, either automatically, by manual input to the partner device 222, or otherwise, a desired medium for delivery of products or services (e.g., by car, by bicycle, by walking). The server computer 202 maintains intermittent or continuous communications over the network 204 with the partner device 222 to ascertain continued availability of the partner device 222 for making deliveries at location of or designated by the partner device 222.

The server computer 202 may receive one or more request of one or more of the customer device 232a or 232b (as may be applicable; and hereafter referred to by reference numeral “232”) operating a browser or app device communicating over the network 204. The request received by the server computer 202 is matched by the server computer 202 to any one or more, as applicable, partner device 222 having product or service available for the location corresponding to the request. If immediate delivery of product or service is requested, then the server computer 202 identifies an available one of the partner device 222 and communicatively notifies the partner device 222 of the requested product or service in order for the partner device 222 to accept or deny readiness to make the delivery of the request. The partner device 222 may “accept” or “deny” the request via communication with the server computer 202. If accepted by the partner device 222 via communication to the server computer 202, the server computer 202 communicates to the partner device 222 over the network 204 the location, product or service, and other requirements of the request by the customer device 232.

Each partner device 222 maintains corresponding stores of products or services for delivery on request by customers 232. The partner 222, on authorization via communicative access to the server computer 202 over the network 204, places purchase orders for products and identifies services available for delivery to customers 232. The partner 222 also communicates over the network 204 an indicator of availability to the server computer 202, for delivery of those products and/or services. The indicator of availability may include a locator of the partner 222, or the partner may be located by GPS 227b, IP address 227a, or other locator of the partner 222 and identity of the location communicated to or detected by the server computer 202.

The server computer 202 maintains in the data store 218 or other memory or storage, as non-exclusive example, in the database 220, the indicated availability and location of the partner. Because products are purchased by the partner 222 via the server computer 202, the server computer 202 ascertains and may maintain in the data store 218, for example, in the database 220, records of products then having been purchased and held in corresponding stores by the partner 222 and ready for delivery and of services then available from the partner 222 for provision. The server computer 202 may also ascertain and maintain in the data store 218, for example, in the database 220, records of product and service delivery having then been made by the partner 222.

Upon delivery of product or service, as applicable, to the customer 232 of the request, the partner 222 communicates a completion message over the network 204 with the server computer 202. The completion message is stored in the data store 218, for example, in the database 220. The server computer 202, in conjunction with the data store 218, records the completion message and updates record(s) of the product or service remaining available for delivery from the partner 222.

The server computer 202 may include, or communicatively connect to, a commerce engine, such as a credit card processor, PayPal or similar payment service and equipment. The server computer 202 collects purchase price for products sold to partner(s) 222, collects prices paid by customer(s) 232 for delivery of those products and of any services, and pays to the partner(s) 222 a portion of the prices paid by customer(s) 232. Transaction of purchases and payments, or any portion of them, respectively, may be electronically conducted or otherwise, according to specifics of the implementation.

Because the server computer 202, in conjunction with the data store 218, maintains records of purchases by partners 222 and purchase and delivery of products and services to customers 232, the server computer 202 may include one or more analytics unit. The analytics unit, or if applicable units, may variously assess storage and management of inventory, storage requirements, handling guidelines, customer identities, customer requests received for product(s) and service(s), products or services purchased, geographical or demographical aspects, or other details, in order to determine and communicate to partners 222 relevant recommendations of particular products or services, as well as other recommendations and advisories.

According to certain non-exclusive embodiments, the communication interface device 210 of or associated with the server computer 202 handles respective communications by the server computer 202 on the network 204 with respective ones of the customers 232, on the one hand, and respective ones of the partners 222, on the other hand. Medium and vehicle of those communications may include various formats and protocols, as may be applicable for the partners 222 and the customers 232, for example, the communication interface device 210 may support one or more wireless networking protocols (e.g., Wifi/IEEE 802.11, or another wireless networking standard), or wired or other wireless general data networks, such as Ethernet or specialized protocol or format, as well as telecommunications/telephony networks such as analog voice networks or digital fiber communications networks or any other suitable type of network and/or protocol.

The communication interface device 210 communicatively connects to the network 204 and to on-demand manager 212, the product manager 216 and the manager interface device 214. The manager interface device 214 logically corresponds the operations of the on-demand manager 212 and the product manager 216, to determine match of respective one of the partner device 222 to request of respective one of the customer device 232, including by product or service availability and delivery medium and location.

The product manager 216 communicates, via the communication interface device 210, with the partner devices 222 to coordinate inventory of product(s) maintained by each partner device 222. The product manager 216 maintains records, such as in the database 220, of each partner device 222 and product purchased by the partner device 222. The product manager 216 also maintains records, such as in the database 220, of product delivered by the partner device 222 to any of the customer device 232. Determination is made by the product manager 216 of current stores of product for each partner device 222, and records are updated in real time to account for delivery of product to customer devices 232.

The on-demand manager 212 communicates, via the communication interface device 210, with the partner devices 222 to coordinate matching of partner devices 222 to requests of the customer devices 232. The on-demand manager 212 maintains records, such as in the database 220, of each respective request of the customer devices 232, and geographically and based on availability and timing determines a partner device 222, respectively, to provide the product or service of the request by the customer device. The on-demand manager 212 in real time messages a particular one of the partner device 222 to deliver the product or service to the customer device 232.

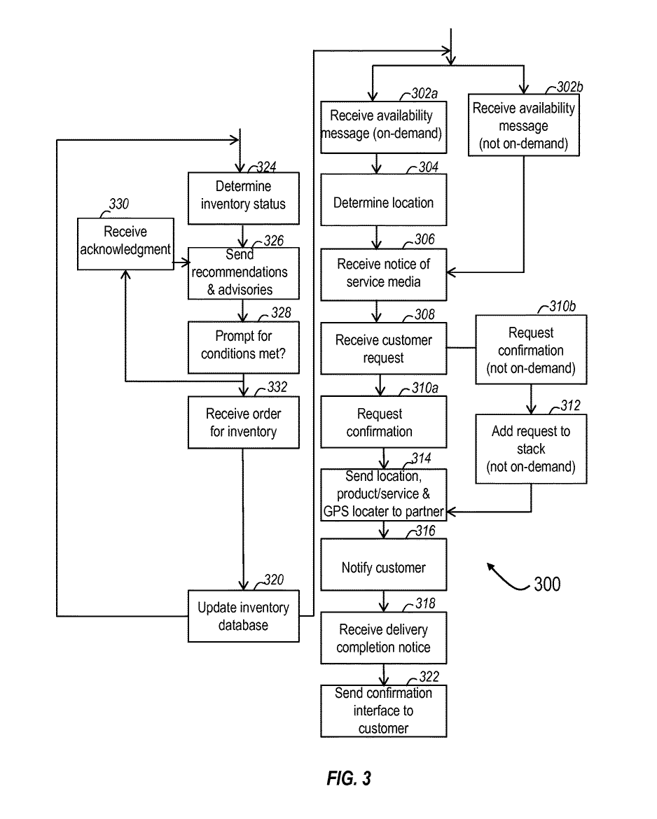

Referring to FIG. 3, a method 300 for on-demand delivery and storage includes receiving an availability message 302a or 302b, for example, by a server computer communicatively connected to a database. The step of receiving 302a is of a ready for on-demand delivery service availability message from a partner communications device, for example, from a data communications network communicatively connected to the server computer. The receiving step 302b is of an availability other than on-demand. If the server computer receives in the step 302a from the partner device a message that the partner is available for making immediate delivery of product or service responsive to requests of customer devices, then the method 300 proceeds from the step 302a. If, instead, the server computer receives in the step 302b from the partner device a message that the partner is available, but not for making immediate (i.e., on-demand) delivery, then the method 300 proceeds from the step 302b.

According to certain embodiments, a presentation engine of the server computer communicates to the partner device, for display at the partner device, a graphical or other interface. The partner device may communicate with the server device through a website application served by the server device to a browser of the partner device, through a mobile user interface of a mobile application running on the partner device and communicatively connected to the server device, or otherwise. The graphical interface may present to the partner device a dynamic content of a website or mobile application interface. Communications between the server computer and the partner device are via the website or mobile application.

A profile of the partner device is maintained by the server computer, for example, in the communicatively connected database. The profile include specific identifiers of the partner device, including an account and information of the account corresponding to the partner device. The account includes registration information of the partner device, historical data on application, product or service usage, previous location, current inventory, and a rating and history of the rating. Bank account identifiers and payment information identifiers may also be included in, or communicatively accessed by the server computer for, the account. Such bank and payment identifiers may be stored and employed with third party banking, payment and security systems and processes.

The method 300 proceeds from the step 302a to a step of determining a location of the partner device by the server computer. In the step 304, the server computer detects the location, such as via IP address or other locator of the partner device, the partner device communicates to the server device the location, for example, based on a GPS location of the partner device or location manually entered and communicated by the partner device, or otherwise the server computer determines the location of the partner device. Location will generally be geographical in nature, however, other relativity of the partner device to requests of customer devices is possible.

If the method 300 proceeds from the step 302b, the location is directed by the partner device to the server computer. For example, the partner device messages the server computer that the partner device will be available for delivery of product or service pursuant to customer request in other than an immediate capacity. In such instance, the partner device may communicate to the server computer a location and time for the location of the partner device, or other indicators corresponding to other than on-demand delivery status.

In a step 306, the server computer receives a notice from the partner device of a service medium for which the partner device will make delivery of product or service. The service medium may be, for example, by pedestrian, vehicle, bicycle, otherwise by hand, or other delivery. The server computer then receives 308 a customer device request for product or service that corresponds to the availability and location of the partner device.

According to certain embodiments, a display engine of the server computer communicates to the customer device, for display at the customer device, a graphical or other interface. The customer device may communicate with the server device through a website application served by the server device to a browser of the customer device, through a mobile user interface of a mobile application running on the customer device and communicatively connected to the server device, or otherwise. The graphical interface may present to the customer device a dynamic content of a website or mobile application interface. Communications between the server computer and the customer device are via the website or mobile application.

On receiving 308 the request of the customer device, the server computer determines a delivery type of the request by the customer device, whether the request is for immediate delivery (e.g., within 15 minutes) or same day delivery (e.g., by 10 pm same day), or otherwise if and as applicable in the implementation. The server computer communicatively requests confirmation from the customer device in a step 310a or 310b. The confirmation request 310a is made if the customer request is for immediate (i.e., on-demand) delivery of product or service. The confirmation request 310b is made if the customer request is for other than on-demand delivery (e.g., same day delivery). If the method 300 proceeds through step 310b, then the server computer sends the request to a partner device, the partner device accepts (or otherwise denies, in which case a next partner device is sent the request for acceptance or denial, and so on) the request for delivery, and adds the customer request to a stack in the step 312. The stack is maintained by the partner device for scheduling deliveries to customers pursuant to requests for other than on-demand delivery.

If, on the other hand, the method proceeds through step 310a, the server computer sends the request to a partner device identified as ready to make deliveries of the product or service, and receives in response an accept (or otherwise deny, in which case a next partner device is sent the request for acceptance or denial, and so on) the request for delivery. On receiving an accept from the partner device, the server computer in a step 314 sends to the partner device a location, product or service identity, and location of the customer device making the request of the step 308. The server computer notifies the customer in a step 316 that the request has been sent to the partner device for fulfillment. Upon fulfillment by delivery of the product or service by the partner device, the partner device sends 318 a delivery completion notice to the server computer. The server computer requests confirmation from the customer device having received delivery, and receives confirmation communicated by the customer device to the server device in a step 322.

Upon the step 318, the server computer updates an inventory record 320 maintained in the database for the partner device. On such update, the method 300 may return to the step 302a or 302b.

Further in the method 300, the server computer makes available to the partner device additional products or services for inventory storage in respect to the partner device. In particular, the server computer determines an inventory status 324 of products and services then maintained by the partner device. The server computer in a step 326 communicatively sends (e.g., for display) to the partner device any recommendations for addition to inventory of products or services, as well as any recommendations or advisories for product maintenance, storage and inventory turnover. The server computer may communicatively request confirmation 328 that product storage and management conditions are met by the partner device, and an acknowledgement of confirmation may be received 330 by the server computer from the partner device.

In a step 332, the server computer may receive from the partner device order(s) for additional inventory of products or services to be provided by the server to the partner for maintenance and storage. The database is updated by the server computer in a step 320 for any added products or services ordered by and made available to the partner device. The method 300 returns to the step 302a or 302b.

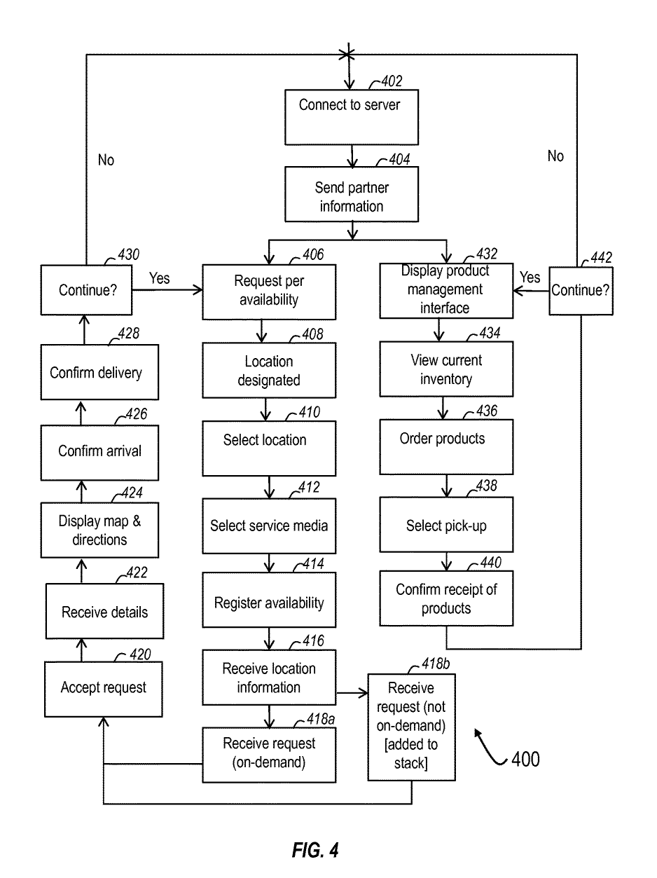

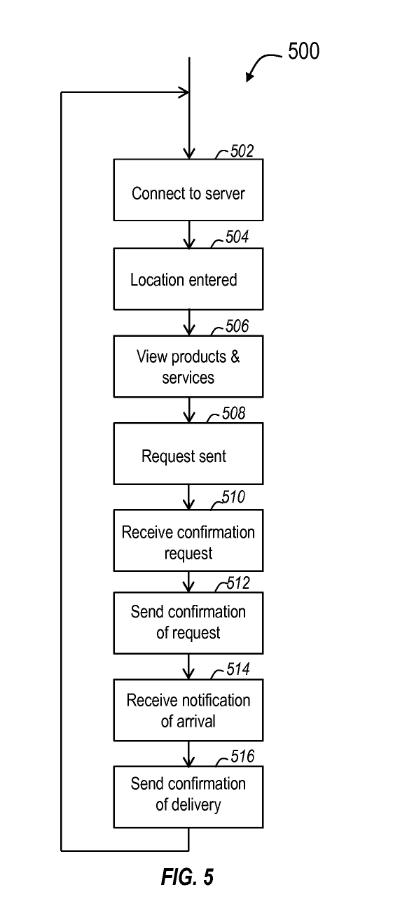

Referring to FIG. 4, a method 400 is performed by the partner device in communicative connection to the server computer. In a step 402, the partner device communicatively connects to the server computer, for example, via a website displayed in a browser of the partner device, via a mobile user interface of a mobile application processed by the partner device, or, if applicable in the embodiment, via another mode of communicative connection. The partner device communicates 404 information of the partner device to the server computer, or else the server computer detects information from the partner device, as may be applicable. The information of the partner device may include, as non-exclusive example, product inventory, storage and ordering corresponding to the partner device, location based deliveries made or to be made to requesting customer devices, as well as history and rating. The information may be stored or maintained by the partner device, the server computer, or combinations.

The partner device may register the partner's availability to deliver product or services to customer device(s), by communicatively requesting 406 to the server computer. Upon registering availability, a location of the partner device is designated 408, for example, the server computer automatically detects the location of the partner device, such as via an IP address or other locator, or the partner device communicates the location to the server computer, such as based on a GPS of the partner device, a manually entered location, or other.

The partner device then communicates 410 to the server computer a selected location for making delivery of products or services, as applicable. The partner device also communicates 412 to the server computer a selected service medium for delivery, for example, by car, by pedestrian, or other. The partner device communicates 414 to the server device to register availability of the partner device for delivering product or service. Availability of service options will depend on partner service location, feedback and rating, as a non-exclusive example.

The partner device receives 416 location-specific information communicated by the server computer, for example, identifier of top-selling products or services, displayed in the partner device. In a step 418a or 418b, the partner device receives from the server computer a request then having been received by the server computer from a customer device. The request received by the partner device may include certain additional information, in addition to specifics of the customer request, for example, specific handling details or others. The request 418a received by the partner device may be for an on-demand delivery of product or service, or else the request 418b may be for other than on-demand delivery and, in which case, the request 418b is from the stack of the partner device.

After receiving the request 418a or 418b, the partner device may communicate acceptance 420 of the request to the server computer. In a step 422, the partner device receives from the server computer any details of the request, such as, for example, location of the customer device lodging the request with the server computer, identity of product or service for delivery, or other details. The partner device then, through communicative connection with the server computer, displays a map and directions 424 for fulfilling the requested delivery.

The partner makes the delivery per the request. Upon arrival at the location of the customer device, the partner device may confirm 426 to the server computer. On making the delivery of product or service according to the customer request, the partner device may communicate confirmation 428 to the server computer.

The method 400 returns in the step 430 to the step 406 if the partner device continues as available for making delivery of products or services or to the step 402 to communicatively reconnect with the server computer if the partner device discontinues as available in the step 430.

Continuing to refer to FIG. 4, upon the steps 402 and 404, the partner device may display a product management interface 432 in communication with the server computer. The partner device, for example, clicks to select or otherwise invokes the product management interface for display in the step 432. From the product management interface, the partner device may view current inventory 434 of products and services then-maintained by the partner device. Also, the partner device may order products 436 by communications with the server computer. Upon ordering products in the step 436, the partner device may select a favored mode for obtaining (e.g., pick-up) of products made available by the server computer. Once ordered products are obtained by the partner device, the partner device may communicate to the server computer confirmation of receipt of products in the step 440.

In a step 442, the partner device may elect to continue product management operations by returning to the step 432 or else discontinue and return to the step 402 of connection to the server computer.

Referring to FIG. 5, a method 500 is performed by the customer device in communicative connection to the server computer. In a step 502, the customer device communicatively connects to the server computer, for example, via a website displayed in a browser of the customer device, via an application user interface of an application program processed by the customer device, or, if applicable in the embodiment, via another mode of communicative connection (e.g., telephone). The customer device communicates 504 information of the customer device to the server computer, or else the server computer detects information from the customer device, as may be applicable. The information of the customer device may include, as non-exclusive example, location of the customer device, desired other location for delivery of product or service, or other. The information may be stored or maintained by the customer device, the server computer, or combinations.

The customer device, via communicative connection to the server computer, may then view 506 in a display of the customer device the available products or services for the location or other criteria. The customer device may select and communicate a request 508 for product or service to the server computer.

If the request of the step 508 is received by the server computer, the customer device receives confirmation 510 of the request from the server computer. The customer device may then again confirm the veracity of the request in a step 512.

Upon successful entry of the request, the customer device receives a notification 514 from the server computer of the arrival of delivery of the requested product or service. If the delivery is as requested, the customer device may send a confirmation of the delivery 516 to the server computer.

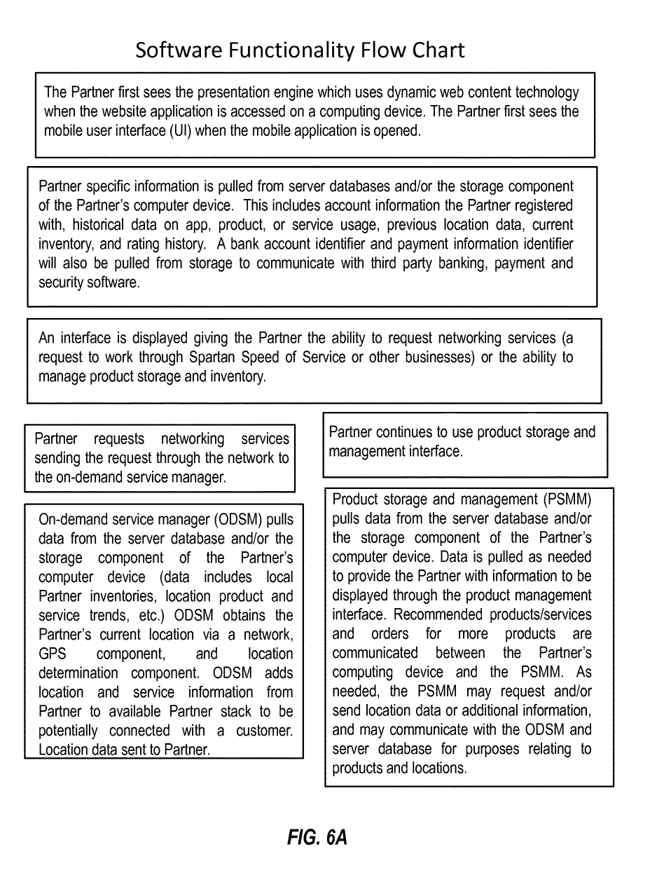

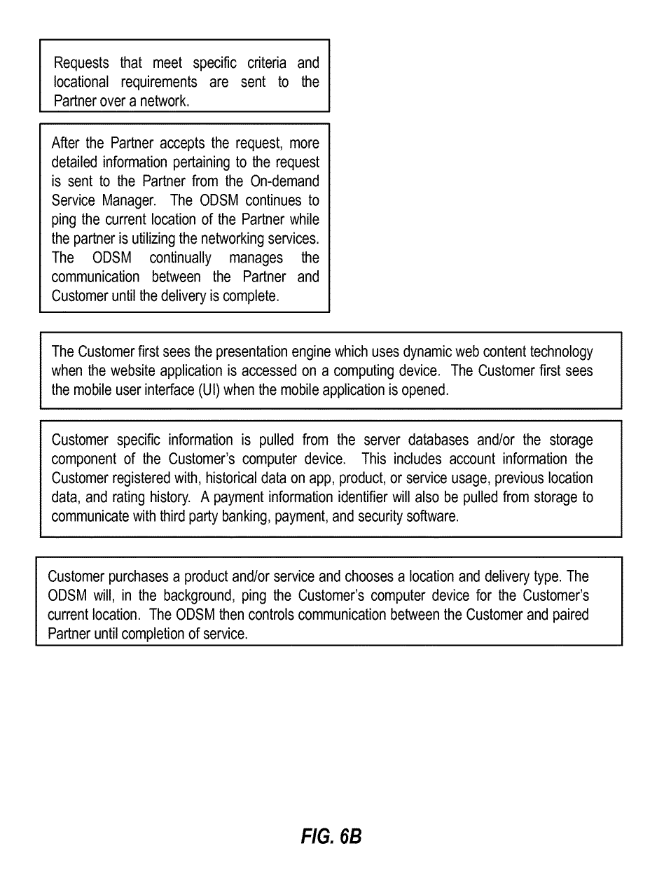

Referring to FIG. 6, further details of operations of the systems and methods are illustrated.

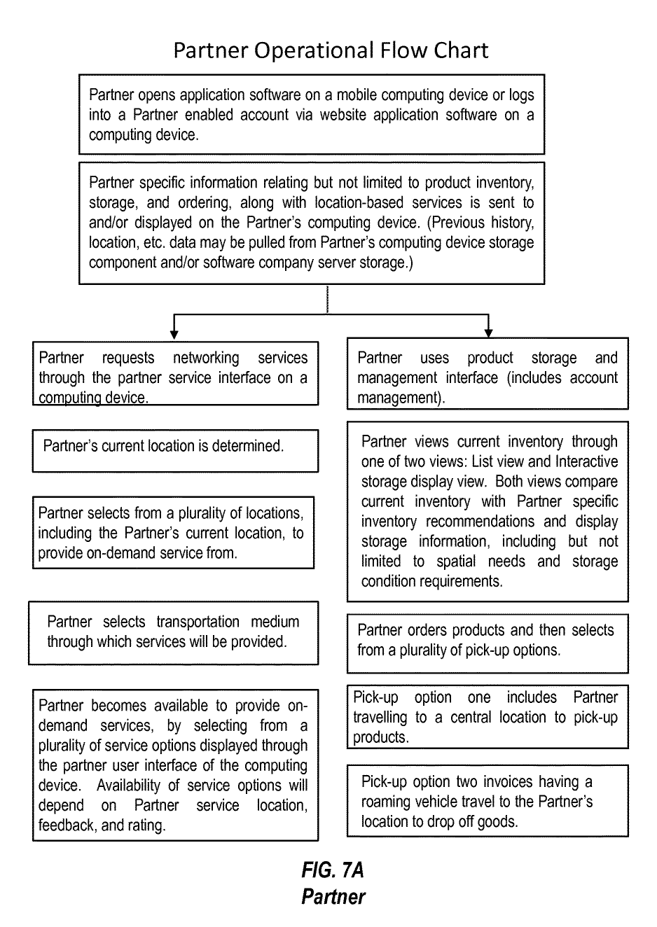

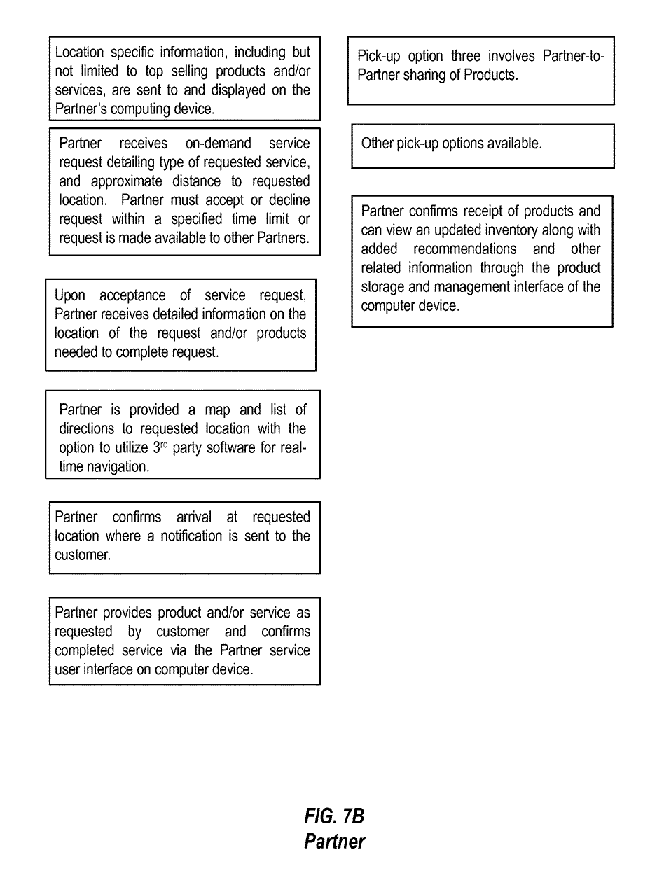

Referring to FIG. 7, further details of operations of the partner device are illustrated.

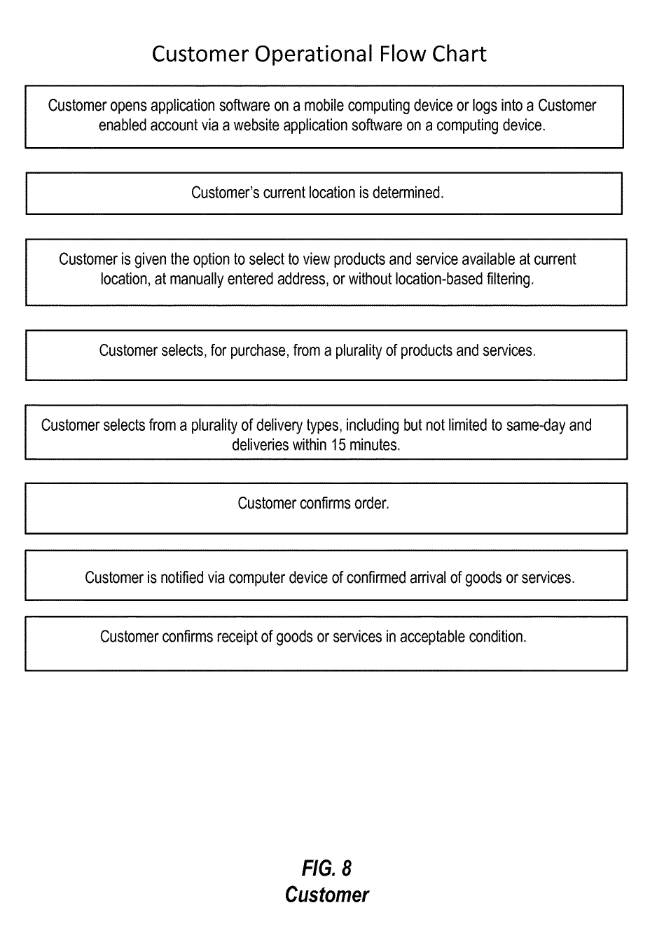

Referring to FIG. 8, further details of operations of the customer device are illustrated.

In the foregoing embodiments, it is contemplated that one or more partner device and one or more customer device communicatively connect to one or more server computer for product or service order, storage, and management and for product or service request, receipt and confirmation. The server computer and any associated database store and maintain inventory and provision of products and services for partner devices. The server computer and any associated database also coordinate requests for products and services by customer devices, and fulfillment of those requests by partner devices.

In certain alternatives, the systems and methods are incorporated, in whole or part, as a service. In other alternatives, the systems and methods are incorporated, in whole or part, in or with a product or service logistics application, map application, directions application, search application or other. Although particular units, modules, or other elements are illustrated as unitary (or not) in the embodiments, it is contemplated that certain of those units, modules or other elements may be included in whole or part as features that interact with or incorporate other units, modules or elements (including, for example, third party parts or elements) or that are combined in whole or part with other units, modules or elements.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system for on-demand product and service delivery by a partner device communicatively connected to a telecommunications network, responsive to a request by a customer device communicatively connected to the telecommunications network, comprising:
a server computer communicatively connected to the telecommunications network, including an on-demand manager and a product manager communicatively connected to a processor and memory, the on-demand manager connecting the customer device to the partner device for fulfillment of the request by delivery of product or service by the partner device, and the product manager providing product purchasable by the partner device for fulfillment of the request by delivery of product to the customer device; and
a database communicatively connected to the telecommunications network, the database includes partner and client records for connecting the customer device to the partner device and product management records for product stored by the partner device for delivery to the customer device.

2. A method for on-demand product and service delivery, comprising:
receiving by a server computer communicatively connected to a network, a request from a customer device communicatively connected to the network;
matching by the server computer the request from the customer device to a partner device at a location corresponding to the customer device, the partner device having registered with the server computer at the location;
sending by the server computer the partner device an identifier of the customer device at the location and a product or service identity for delivery to the customer device for the request;
receiving by the server computer a confirmation message from the partner device that the request is fulfilled by delivery of the product or service by the partner device to the customer device; and
updating by the server computer a record of the product or service in a database communicatively connected to the server computer

3. The method of claim 2, further comprising:
offering by the server computer for purchase by the partner device, the product for delivery to the customer device on request in the step of receiving the request;
selling by the server computer the product to the partner device;
storing by the server computer in the database a record of the step of selling, relative to the partner device;
updating by the server computer the record of the product or service in the database.

4. A system for on-demand product and service delivery by a partner device communicatively connected to a telecommunications network, responsive to a request by a customer device communicatively connected to the telecommunications network, comprising:
a server computer communicatively connected to the telecommunications network, including an on-demand manager and a product manager communicatively connected to a processor and memory, the on-demand manager connecting the customer device to the partner device for fulfillment of the request by delivery of product or service by the partner device, the on-demand manager includes instructions for:
receiving an availability message from the partner device on the network;
determining a location of the partner device;
determining in a database an inventory of the product or service then-maintained by the partner device;
receiving a request from the customer device on the network;
determining a location of the customer device;
matching the request via the location of the customer device to the partner device via the location of the partner device and the inventory then-maintained by the partner device;
sending the partner device an identifier of the customer device and a product or service identity for delivery to the customer device for the request;
receiving a confirmation message from the partner device that the request is fulfilled by delivery of the product or service by the partner device to the customer device; and
updating a record of the product or service in the database.

5. The system of claim 4, wherein the product manager includes instructions for:
sending an offer for sale of product to the partner device;
selling the product to the partner device;
storing in the database a record of the sale of the product to the partner device;
updating an inventory in the database of the product for the partner device.

6. A method for on-demand product storage and delivery via a data communications network, comprising:
receiving an availability message from a partner device communicatively connected to the network;
determining a location of the partner device;
determining in a database an inventory of the product then-maintained by the partner device;
receiving a request for the product from a customer device on the network;
determining a location of the customer device;
matching the request via the location of the customer device to the partner device via the location of the partner device and the inventory then-maintained by the partner device;
sending the partner device an identifier of the customer device and an identity of the product for delivery to the customer device for the request;
receiving a confirmation message from the partner device that the request is fulfilled by delivery of the product by the partner device to the customer device; and
recording an update to a record of the product for the partner device.

7. A method for on-demand product storage and delivery via a data communications network, comprising:
sending an offer for sale of a product to a partner device communicatively connected to the network;
selling the product to the partner device;
storing in a database a record of the sale of the product to the partner device; and
updating an inventory in the database of the product for the partner device.

8. The method of claim 6, further comprising:
sending an offer for sale of the product to the partner device communicatively connected to the network;
selling the product to the partner device;
storing in a database a record of the sale of the product to the partner device; and
updating an inventory in the database of the product for the partner device.

9. The method of claim 3, further comprising:
receiving by the server computer a purchase price for the product from the customer device; and
remitting to the partner device the amount received from the partner device in the step of selling, plus a portion of the difference between (i) the purchase price for the product of the step of receiving by the server computer the purchase price and (ii) the amount received from the partner device in the step of selling.

10. The method of claim 3, further comprising:
delivering by the server computer to the partner device a recommendation notice selected from the group consisting of: a preferred product or service, a practice of storage management of product, and a handling guide of product.

11. A method for on-demand product or service receipt by a customer device via a communication network, comprising:
sending by the customer device to a server computer a request for the product or service, the request includes a requirement of either of on-demand delivery and same day delivery;
receiving from the server computer an acknowledgement that the product or service will be delivered as per the requirement; and
purchasing by the customer device via communication with the server computer over the network the product or service of the request.

12. The method of claim 6, wherein the request includes a required delivery method;
further comprising:
stacking by the partner device the request with any other requests that include similar delivery method.
